(19) United States
(12) Patent Application Publication
(10) Pub. No.: US 2007/0098206 A1
(43) Pub. Date: May 3, 2007

(54) SPEAKER GRILLE AND SPEAKER DEVICE

(75) Inventors: Tomiaki ANDO, Yamagata (JP); Koji Matsumoto, Yamagata (JP); Kian Ohta, Yamagata (JP)

Correspondence Address: ARENT FOX PLLC, 1050 CONNECTICUT AVENUE, N.W., SUITE 400, WASHINGTON, DC, 20036, US

(73) Assignees: Pioneer Corporation, Tokyo (JP); TOHOKU PIONEER CORPORATION, Yamagata (JP)

(21) Appl. No.: 11/553,137

(22) Filed: Oct. 26, 2006

(30) Foreign Application Priority Data
Oct. 28, 2005 (JP) 2005-314514

(51) Int. Cl. H04R 1/02

(52) U.S. Cl. 381/391; 381/386

(57) ABSTRACT

It is an object of the invention to provide an improved speaker grille and an improved speaker device capable of preventing a deterioration of the quality of a sound propagated in an inclined direction, using only a simple structure. The speaker device has a diaphragm and a grille provided in front of the diaphragm. The grille is formed in a position in front of the diaphragm, and has an open area in which an entire diameter of the diaphragm is opened in the right ahead direction of the diaphragm, also has shield areas formed on both sides of the open area for shielding part of the diaphragm viewed in an inclined direction, thereby making it possible to prevent a sound quality deterioration in the inclined direction using a simple structure. Moreover, since the grille is formed with the open area in the right ahead direction, there is no sound quality deterioration in the right ahead direction.

### BACKGROUND OF THE INVENTION

The present invention relates to a speaker grille and a speaker device.

The present application claims priority from Japanese Application No. 2005-314514, the disclosure of which is incorporated herein by reference.

A vehicle speaker or the like is usually provided with a speaker grille on its front side for protecting its diaphragm or the like. Generally, a vehicle speaker is provided such that a listener seldom listens in a right ahead direction of the speaker, but usually in an inclined direction forming an inclined angle with the right ahead direction. For this reason, there have been known various types of speaker grilles providing a directivity satisfying such an inclined direction. For example, Japanese Unexamined Patent Application Publication No. 2002-305784 has disclosed a speaker grille in which a plurality of ring-shaped members of different diameters are concentrically arranged and supported by ribs, with the members on one side arranged at a pitch narrower than on the other side. In such a speaker grille, a sound pressure distribution on one side having the narrower pitch will rise, thereby providing a directivity to a sound wave (compression wave).

However, since the above-mentioned speaker has a complex structure in which a plurality of ring-shaped members of different diameters are concentrically arranged, such a speaker has only a low strength and requires a long time in its manufacturing. For this reason, it has been demanded that a speaker grille be made simpler in its structure.

On the other hand, a compression wave emitted in an inclined direction from a diaphragm is a synthesized wave containing different phase components corresponding to different paths from different portions of vibration surface of the diaphragm. As a result, a compression wave emitted in a specifically inclined direction will suffer from an interference caused by some inverted phase components, resulting in a deteriorated sound quality in a specified frequency range.

### SUMMARY OF THE INVENTION

The present invention is to solve the above-mentioned problem and makes this as one of its tasks. Namely, it is an object of the present invention to provide an improved speaker grille and thus an improved speaker device capable of preventing a deterioration of the quality of a sound propagated in an inclined direction, using only a simplified structure.

In order to achieve the foregoing object, the present invention has at least the following configurations included in the following aspects.

According to one aspect of the present invention, there is provided a speaker grille provided on a front side of a speaker having a diaphragm. The grille comprises: an open area formed in front of the diaphragm and allowing an entire diameter of the diaphragm to be open in a right ahead direction of the diaphragm; and shield are as formed outside the open area and shielding part of the diaphragm viewed in an inclined direction of the diaphragm.

According to another aspect of the present invention, there is provided a speaker device having a diaphragm and a speaker grille provided in front of the diaphragm. The speaker grille comprises: an open area formed in front of the diaphragm and allowing an entire diameter of the diaphragm to be open in a right ahead direction of the diaphragm; shield areas formed outside the open area and shielding part of the diaphragm viewed in an inclined direction of the diaphragm.

The speaker device according to one embodiment of the present invention has a diaphragm and a grille provided in front of the diaphragm. The grille is formed in a position in front of the diaphragm, and has an open area in which an entire diameter of the diaphragm is opened in a right ahead direction of the diaphragm, also has shield areas formed on both sides of the open area for shielding part of the diaphragm viewed in an inclined direction.

With regard to the speaker device having the above-described configuration, shield areas formed in the speaker grille are located on both sides of the open area, thereby shielding part of the diaphragm viewed in an inclined direction thereof. Therefore, among compression waves emitted from an inclined surface of the diaphragm, part of the compression waves along inclined direction having a predetermined angle is shielded by the shield areas. In this way, it is possible to inhibit a sound quality deterioration in a specific frequency range which will otherwise be caused due to interference of phase component corresponding to path difference from various portions of the diaphragm.

### BRIEF DESCRIPTION OF THE DRAWINGS

These and other objects and advantages of the present invention will become clear from the following description with reference to the accompanying drawings, wherein:

FIG. 1 is a front elevation showing a speaker device according to one embodiment of the present invention;

FIG. 2 is a cross sectional view taken along A-A line of the speaker device shown in FIG. 1;

FIG. 3 is a cross sectional view taken along B-B line of the speaker device shown in FIG. 1;

FIG. 4 is a perspective view showing a grille of FIG. 1 when viewed from the front side of the speaker device;

FIG. 5 is a perspective view showing a grille of FIG. 1 when viewed from the back side of the speaker device;

FIG. 6 is a front view of the grille shown in FIG. 1;

FIG. 7 is an explanatory view showing a path difference of a sound wave (compression wave) emitted in an inclined direction inclining a predetermined angle from the speaker center axis O towards y-axis direction;

FIG. 8 is an explanatory view showing a path difference of a sound wave (compression wave) emitted in an inclined direction inclining a predetermined angle from the speaker center axis O towards x-axis direction;

FIG. 9 is a graph showing a frequency response in the right ahead direction (0°) of the speaker device 1 equipped with the grille 4 formed according to an embodiment of the present invention, and that of a conventional speaker device equipped with a conventional grille; and

FIG. 10 is a graph showing a frequency response in an inclined direction (30°) of the speaker device 1 equipped with the grille 4 formed according to an embodiment of the present invention, and that of a conventional speaker device equipped with a conventional grille.

### DETAILED DESCRIPTION OF THE PREFERRED EMBODIMENTS

In the following, description will be given to explain a speaker device according to one embodiment of the present invention, with reference to the accompanying drawings.

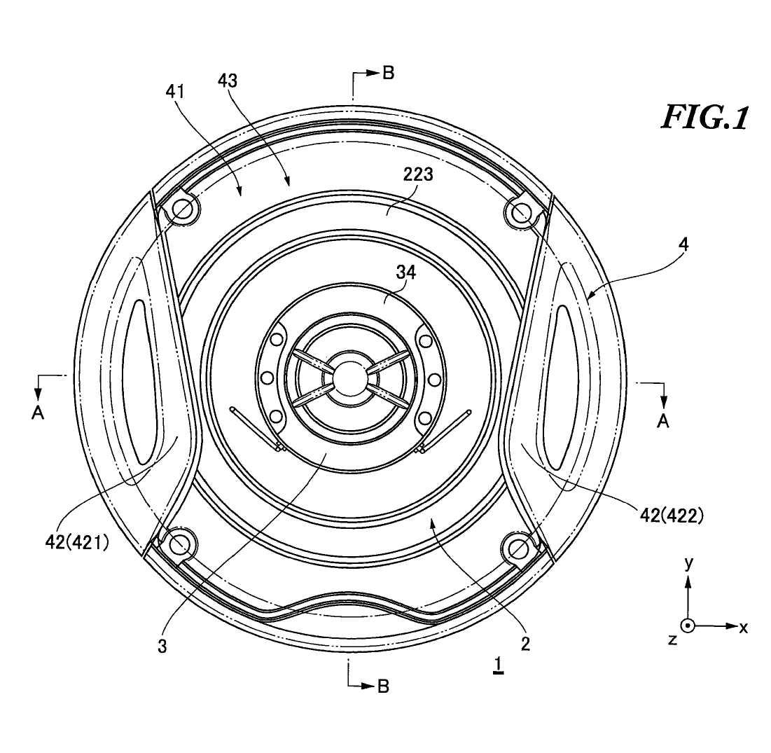

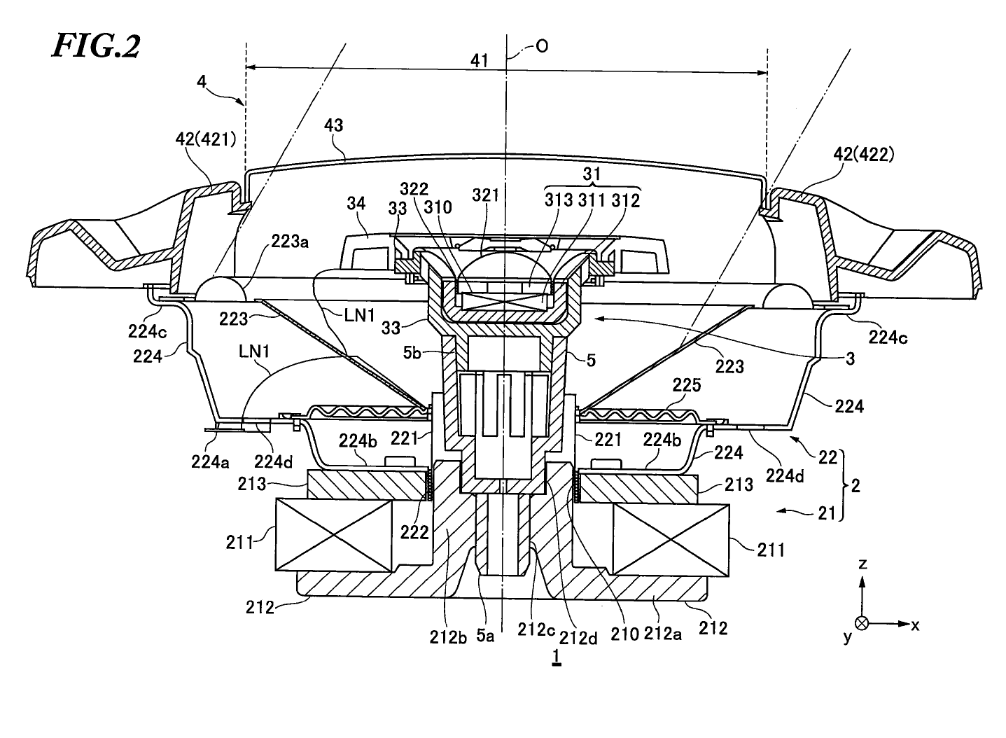

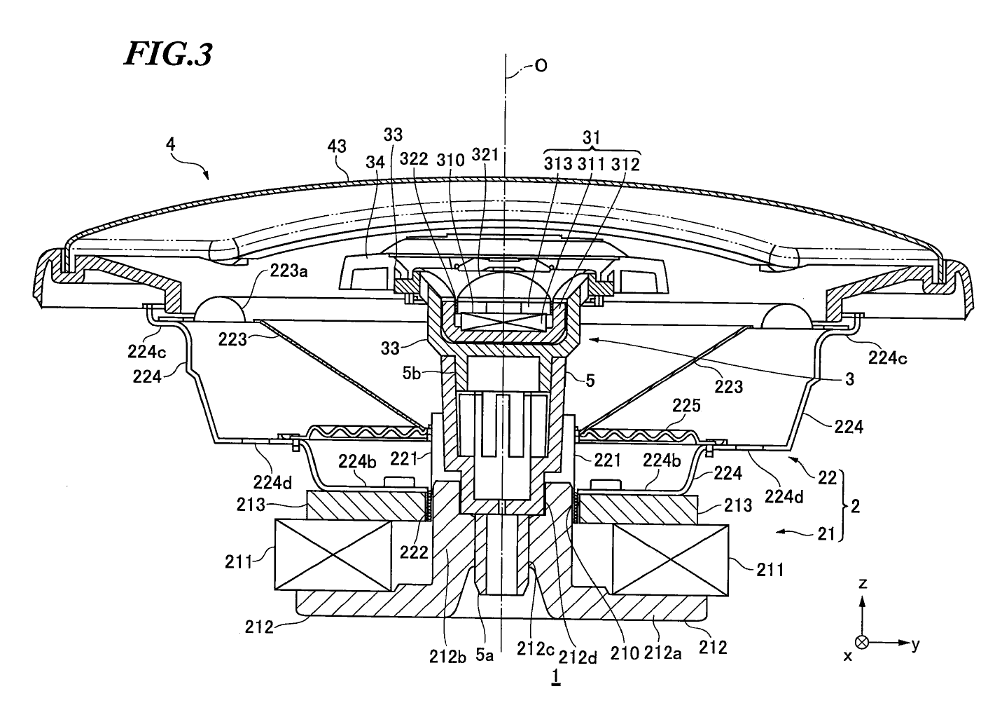

FIG. 1 is a front view showing the speaker device 1 according to one embodiment of the present invention. FIG. 2 is a cross sectional view taken along A-A line of the speaker device shown in FIG. 1. FIG. 3 is a cross sectional view taken along B-B line of the speaker device 1 shown in FIG. 1.

As shown in FIGS. 1 to 3, the speaker device 1 according to the present embodiment includes two concentrically arranged speakers. In detail, the speaker device 1 includes a low-pitched sound playback speaker 2, a high-pitched sound playback speaker 3, and a grille 4. The grille 4 corresponds to an embodiment of a speaker grille according to the present invention. The low-pitched sound playback speaker 2 and the high-pitched sound playback speaker 3 are connected by virtue of a support member 5.

Here, the speaker device 1 is a coaxial type two-way speaker, with the low-pitched sound playback speaker 2 disposed close to the front side of the speaker device and the high-pitched sound playback speaker 3 close to the rear side thereof in a mutually coaxial relation. However, the speaker device 1 should not be limited to the above-mentioned configuration and it is possible for the speaker device to be composed of single one speaker. In fact, the low-pitched sound playback speaker 2 may be a speaker device capable of low-pitched sound playback or medium-pictured sound playback, while the high-pitched sound playback speaker 3 may be a speaker device capable of medium-pitched sound playback or high-pitched sound playback.

[Low-Pitched Sound Playback Speaker 2]

The low-pitched sound playback speaker 2, as shown in FIGS. 1 to 3, includes a magnetic circuit 21 and a vibration system 22. The magnetic circuit 21 can be an external type magnetic circuit or an internal type magnetic circuit. The magnetic circuit 21 of the present embodiment is an external type magnetic circuit, including a magnet 211, a pole piece 212, and a plate 213. The magnet 211 is ring-shaped and formed of a permanent magnet such as a neodymium magnet, a samarium cobalt magnet, an Alnico magnet, and a ferrite magnet. The pole piece 212 is formed so that it has an inverted generally T-shaped section, as shown in FIG. 2. Further, as shown in FIG. 2, the pole piece 212 includes a yoke 212a, a center pole 212b, and openings 212c and 212d. The yoke 212a is formed into a flange member and positioned under the ring-shaped magnet 211. The center pole 212b has a cylindrical shape and a conical concave portion on the lower side thereof close to its center axis. Further, the center pole 212b is formed with an opening 212c on the lower side thereof and another opening 212d on the upper side thereof. The opening 212c and the opening 212d are communicated with each other along the center axis. In more detail, the opening 212d extends from a position near a generally central portion of the center pole 212b to the upper side thereof, while the opening 212c extends from the position near a generally central portion of the center pole 212b to the lower side thereof. The diameter of the opening 212d is larger than that of the opening 212c, while the support member 5 is inserted through the openings 212c and 212d.

The ring-shaped plate 213 is positioned over the ring-shaped magnet 211. A magnetic gap 210 is formed between the inner circumferential surface of the plate 213 and the outer periphery surface of the pole piece 212, thereby allowing the magnetic flux produced by the magnet 211 to be collected in the magnetic gap 210.

As shown in FIGS. 1 to 3, the vibration system 22 includes a voice coil bobbin 221, a voice coil 222, a diaphragm 223, a speaker frame (frame) 224, and a damper 225. The voice-coil bobbin 221 has a cylindrical shape, with its lower end being wound around by the voice coil 22. The voice coil 222 wound around the lower end of the voice-coil bobbin 221 is positioned in the magnetic gap 210 formed between the plate 213 and the pole piece 212. An electrically conductive wire LN1 is electrically connected with the voice coil 222, while the other end of the electrically conductive wire LN1 is electrically connected to a terminal section 224a provided on the speaker frame 224. Here, the diaphragm 223 can be formed into various configurations including a conical shape. In practice, the diaphragm 223 may be formed of various materials such as a paper, a high molecule material, and a metal. The edge of the diaphragm 223 is fixed to the frame 224 through an edge portion 223a. The edge portion 223a is formed to be flexibly movable with respect to the movement of the diaphragm 223. Specifically, the edge portion 223a can function as a terminal for an acoustical vibration of the diaphragm 223, also as means for supporting the perimeter of the diaphragm 223 and holding the same in a predetermined position, as means for preventing a lateral vibration of the diaphragm 223, and as a shield for preventing a sound wave on the back side of the diaphragm 223 from interfering into the sound wave on the front side thereof.

The frame 224 has a function of supporting various essential components of the speaker device 1. In detail, the frame 224 is formed into an upwardly open structure, with its bottom portion 224b disposed on the plate 213 and its upper portion 224c fixed with the edge portion 223a. Moreover, a flange portion 224d for supporting the damper 225 is formed near the generally central portion of the frame 224.

Here, the damper 225 is provided to freely movably support the voice bobbin 221. In more detail, the damper 225 is formed so that it has a corrugated cross section, with its outer perimeter portion fixed and its inner circumferential portion fixed with the diaphragm 223.

[Support Member 5]

The support member 5 is provided between the low-pitched sound playback speaker 2 and the high-pitched sound playback speaker 3 so as to support the high-pitched sound playback speaker 3 on the low-pitched sound playback speaker 2. For example, an engaging portion 5a for engaging into the openings 212c and 212d of the pole piece 212 is formed on the lower end of the support member 5. An opening 5b is formed on the upper end of the support member 5, while a frame portion 33 of the high-pitched sound playback speaker 3 is engaged into the opening 5b.

[High-Pitched Sound Playback Speaker 3]

The high-pitched sound playback speaker 3, as shown in FIGS. 1 to 3, includes a magnetic circuit 31 and a vibration system 32. The magnetic circuit 31 can be an external type magnetic circuit or an internal type magnetic circuit. The magnetic circuit 31 of the present embodiment is an internal type magnetic circuit, including a magnet 311, a yoke 312, and a plate 313.

The magnet 311 has a solid cylindrical shape and is formed of a permanent magnet such as a neodymium magnet, a samarium cobalt magnet, an Alnico magnet, and a ferrite magnet. The yoke 312 is formed so that it has a U-shaped section, while the magnet 311 is mounted on the bottom surface thereof. The plate 313 is a ring-shaped member and mounted on the magnet 311. A magnetic gap 310 is formed between the outer periphery of the plate 313 and the inner circumferential surface of the plate 312, thereby allowing magnetic flux produced by the magnet 311 to be collected in the magnetic gap 310.

The vibration system 32 includes a diaphragm 321 and a voice coil 322. The diaphragm 321 is formed in a manner such that its central portion has a dome-like shape and its outer periphery surface has a cone-like shape, thereby forming a U-shaped cross section in which the voice coil is disposed in an intermediate position. The perimeter portion of the diaphragm 321 is supported by the frame 33 and the voice coil 322 is supported by the diaphragm 321 in the vicinity of the magnetic gap 31. Further, the electrically conductive wire LN1 extending from the terminal section 224a is electrically connected to the voice coil 323 through a shield cover 34. The frame 33 is formed on its lower portion with an engagement portion 33a for engaging into the opening of the support member 5, with a magnetic circuit 31 being arranged inside. The shield cover 34 is disposed on the front side of the frame 33.

As shown in FIG. 2 and FIG. 3, the shield cover 34 is formed along the perimeter of the frame 33, while the outer diameter of the shield cover 34 is equal to about ⅔ of the outer diameter of the diaphragm 223. The shield cover 34 has a function of shielding or reflecting part of the compression wave emitted from the central portion of the diaphragm 223. Further, the shield cover 34 is formed to cover the central portion of the diaphragm 223 in front of the diaphragm, while its inclined portion is formed to cover part of the vibration surface of the diaphragm 223.

[Grille 4]

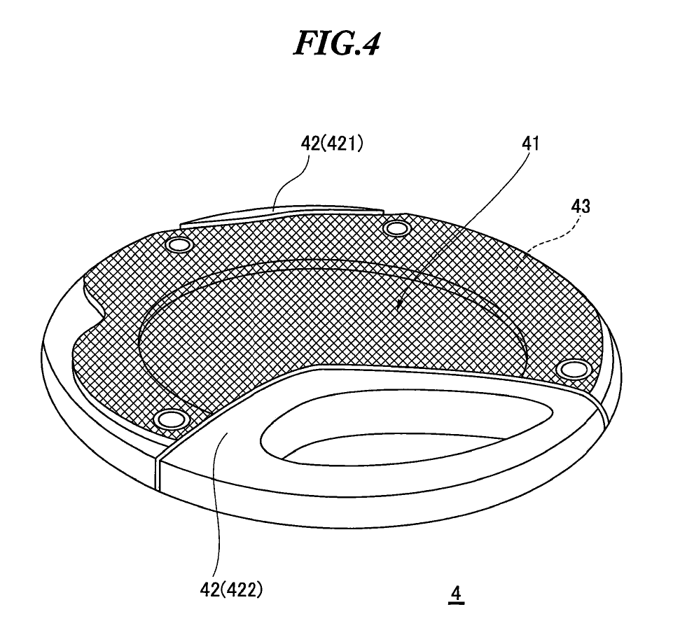

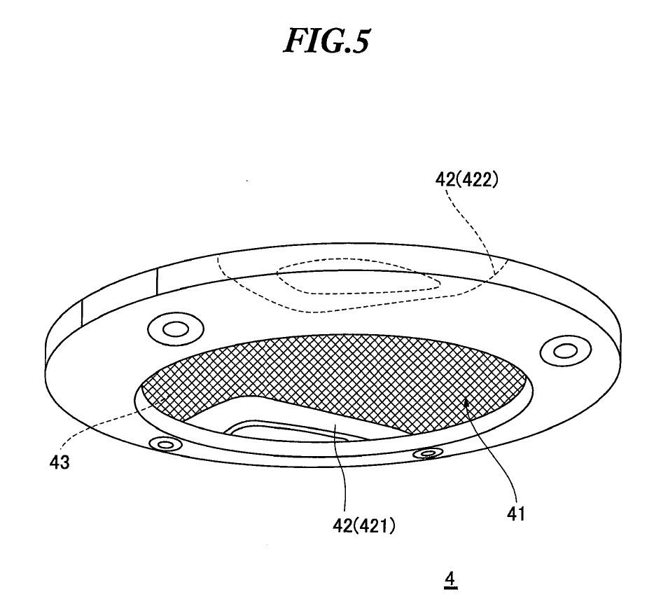

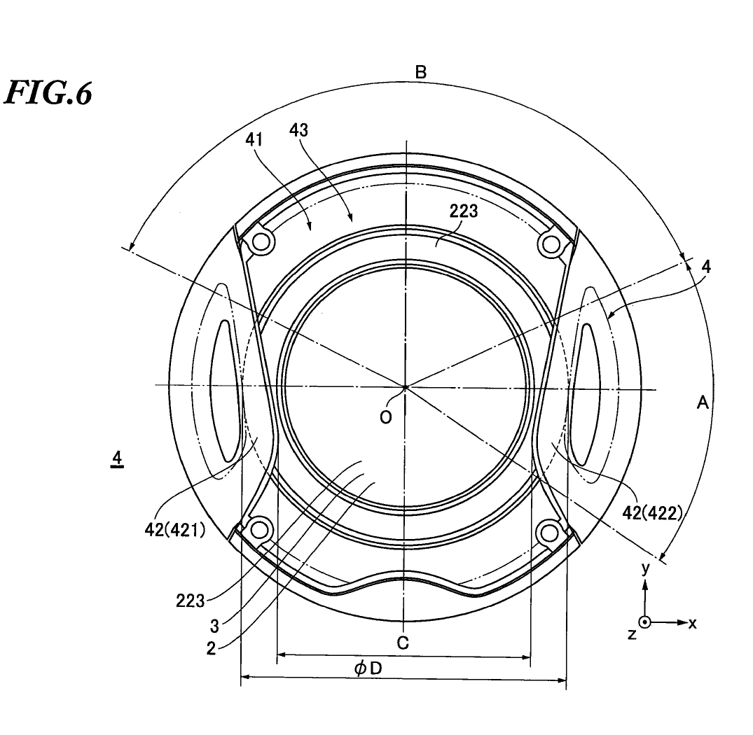

FIG. 4 is a perspective view of the speaker grille shown in FIG. 1 when viewed from the front side. FIG. 5 is a perspective view of the speaker grille shown in FIG. 1 when viewed from the backside. FIG. 6 is a front view illustrating the speaker grille shown in FIG. 1. As shown in FIGS. 1 to 6, the grille 4 has an open area 41, shield areas 42, and a protection cover (punched net) 43.

The open area 41 is formed on the front position of the diaphragm 223, while the diaphragm 223 covering its entire diameter is formed to be in an open state when viewed from its front side.

The shield areas 42 are formed on both sides of the open area 41, while part of the diaphragm 223 is shielded when viewed in an inclined direction. Further, as shown in FIGS. 2 and 3, the shield areas 42 include two areas arranged on the left and right sides of the open area 41 in the x-axis direction, thereby shielding part of the vibration surface of the diaphragm 233 on the left or right side.

In more detail, as shown in FIGS. 2 and 3, the shield areas 42 include a first shield area 421 and a second shield area 422 located on the left and right sides of the open area 41 in the x-axis direction. In the present embodiment, the first shield area 421 and the second shield area 422 are formed symmetrically on the left and right sides. The first shield area 421 is formed to shield part of the left or right vibration surface of the diaphragm 223 in an inclined direction, while the second shield area 422 is formed into a shape not shielding the vibration surface of the diaphragm 322 in an inclined direction. Moreover, the shield areas 42 serve to shield an area in the vicinity of an edge portion 223a of the diaphragm 223 on the front side thereof. In fact, the shield areas 42 can also be formed into a shape capable of shielding, in front of the diaphragm 223, an area near part of an edge portion 223a of the diaphragm 223 and part of the vibration surface of the diaphragm 223a. Here, the shield areas 42 can be made of various materials including a metal material such as iron or the like, a resin material such as ABS (ACRYLONITRILE-BUTADIENE-STYRENE) resin or the like.

The protection cover (punched net) 43 is formed with a plurality of apertures and provided to cover the open area 41. Such a protection cover 43 may be formed of a metal material such as iron or the like, a resin material such as ABS resin or the like. The compression wave radiated from the diaphragm will be transmitted through the protection cover by way of the apertures formed in the protection cover 43, with an acoustic load being low at least in the right ahead direction.

Next, description will be given to explain an example of the grille 4. As shown in FIGS. 1 to 6, the grille 4 is formed with arm-shaped shield areas 42 located on both the left and right sides thereof for adjusting a directivity. In fact, the shield areas 42 are formed to cover only the edge portion 223a of the diaphragm 223 when viewed from the front side, or to cover both the edge portion 223a and the vibration surface of the diaphragm 223. Preferably, as shown in FIG. 6, the shield areas are formed within an angle range A of 55-80° predetermined in the maximum circumferential direction of the diaphragm 223. Preferably, the second shield area 422 is formed such that its numerical aperture (a minimum size C between the first and second shield areas 421 and 422/a maximum diameter [symbol] D of the diaphragm) in the horizontal direction (x-axis direction) is about 65%-80%. Further, it is preferable not to form an acoustic load in the vertical direction (y-axis direction) of the grille, but to open an arc B in the circumferential direction to an angle of 90°. Moreover, as shown in FIGS. 2 and 4, the shield areas 42 are formed in a manner such that when it is viewed in an inclined direction forming a predetermined angle such as 30° with the front axis (center axis O of the speaker), its shield area 422 will cover part of the diaphragm 223, with no acoustic load based on the grille 4 occurring in other directions. Various sizes and shapes such as the foregoing angle range A, numerical aperture, angle B and the like can be properly set according to an external environment of the speaker device 1, as well as acoustic performances of the low-pitched sound playback speaker 2 and the high-pitched sound playback speaker 3.

A brief description will now be given to explain an operation of the speaker device 1 having the above-described structure. Namely, an electrical signal is applied from the terminal 224a to the voice coils 222,322 through the electric conductive wire LN1. In this way, driving forces will occur in the voice coils 222 and 322, thereby causing the diaphragms 223,321 to vibrate in the axial direction O (z-axis direction) of the speaker device 1. As a result, the speaker device 1 emits a sound wave (compression wave) in the right-ahead direction.

[Right-Ahead Direction (Center Axis Direction)]

At this time, the compression wave emitted from the diaphragm 223 in the right-ahead direction (z-axis direction) of the speaker device 1 is transmitted through the open area 41 of the grille 4. In more detail, the compression wave is emitted to the front side through the protection cover 43 covering the open area 41. At this moment, an acoustic load on the protection cover 43 is almost zero.

[Inclined Direction (Inclined with Respect to Y-Axis Direction)]

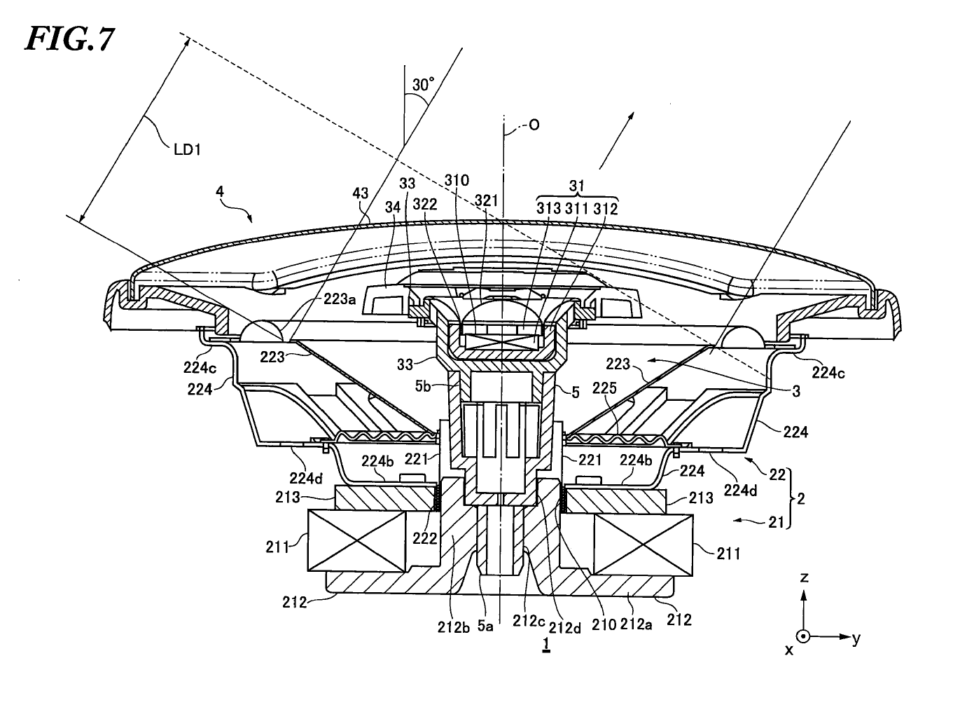

FIG. 7 is an explanatory sectional view showing a path difference of a sound wave (compression wave) emitted in an inclined direction inclining a predetermined angle from the center axis O of the speaker towards the y-axis direction. For example, as shown in FIG. 7, when a listening is performed in an inclined direction (30°) with respect to the center axis O of the speaker device, a sound wave (compression wave) from various portions of the vibration surface of the diaphragm 223 of the speaker device 1 will have a maximum path difference LD1. For example, with regard to a speaker provided with a diaphragm having a diameter of 10 cm, if a listening is performed in an inclined direction 30°, a maximum path difference LD1 will be about 0.036 m, as shown in the following equation (1). Such a path difference 0.036 m is equal to a half wavelength of the sound wave having a frequency of about 4.7 kHz. In this way, once there is an interference from a sound wave (compression wave) having a phase deviation which is the half wave-length, i.e., a sound wave having a phase deviation of 180°, a sound pressure level will decrease.

$$\begin{matrix}Wavelength = sound speed / frequency \\ = 340 ( m \text{/} s ) / 4700 ( Hz ) \\ = 0.072 ( m ) \\ = 0.036 ( m ) \times 2 \\ = half wavelength \times 2\end{matrix} \qquad ( 1 )$$

[Inclined Direction (Inclined with Respect to X-Axis Direction)]

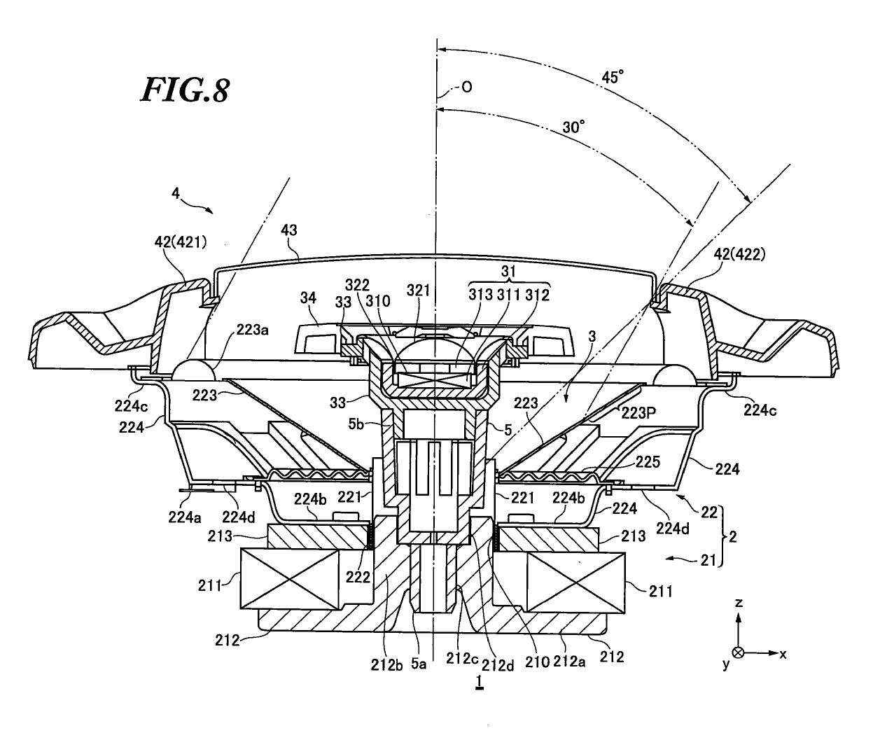

FIG. 8 is an explanatory sectional view showing a sound wave (compression wave) emitted in an inclined direction inclining a predetermined angle from the center axis O of the speaker towards the x-axis direction. For example, as shown in FIGS. 1 to 6 and FIG. 8, since the shield areas 42 are formed into a shape capable of shielding part of the diaphragm viewed in an inclined direction of the diaphragm 223, part of the compression wave transmitting along an inclined direction (30°) inclining from the center axis O toward the x-axis direction will be shielded by the shield areas 42, with part of the compression wave being reflected.

In more detail, as shown in FIG. 8, a compression wave emitted from part of the left or right portion of the vibration surface of the diaphragm 223, for example, the whole or part of the compression wave emitted from an area 223p near the upper end of the diaphragm 322 close to the second shield area 422 can be shielded, so that it is possible to remarkably reduce an interference with a compression wave emitted from an opposed vibration surface of the diaphragm 223, thereby making it possible to prevent a decrease of sound pressure level, thus preventing a sound quality deterioration.

[Comparison]

In order to confirm the performance of the speaker device formed according to one embodiment of the present invention, the inventors of the present application have conducted a comparison between the grille 4 formed with the shield areas 42 according to one embodiment of the present invention and a conventional grille, by measuring and comparing frequency responses in the right ahead direction (0°), an inclined direction (30°) of both grilles.

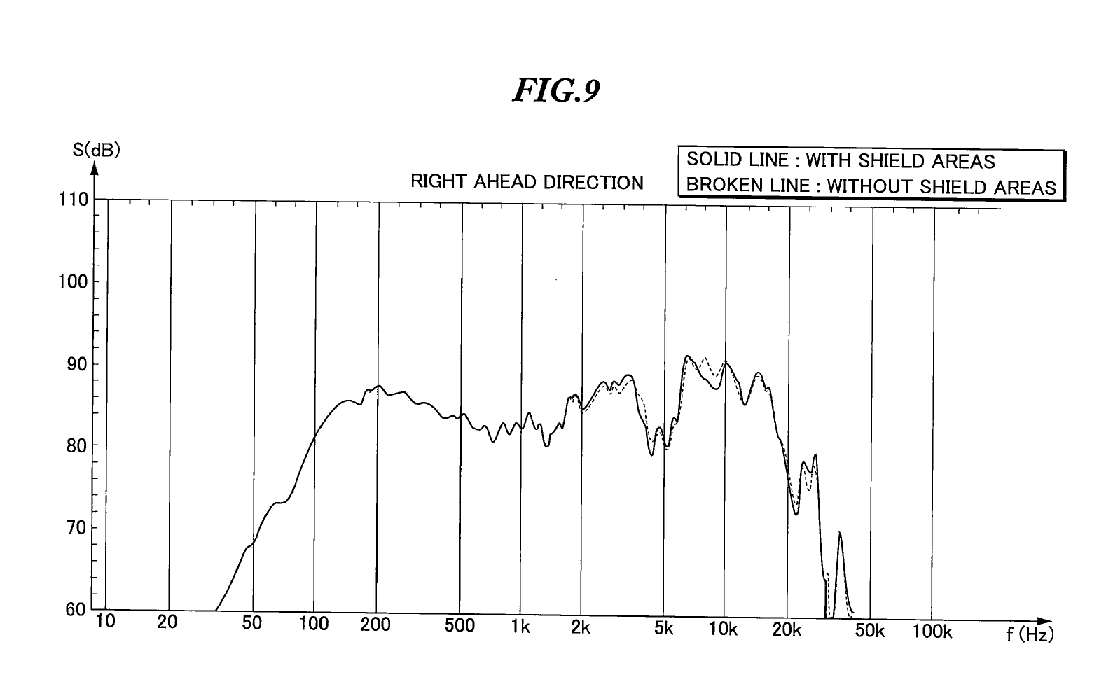

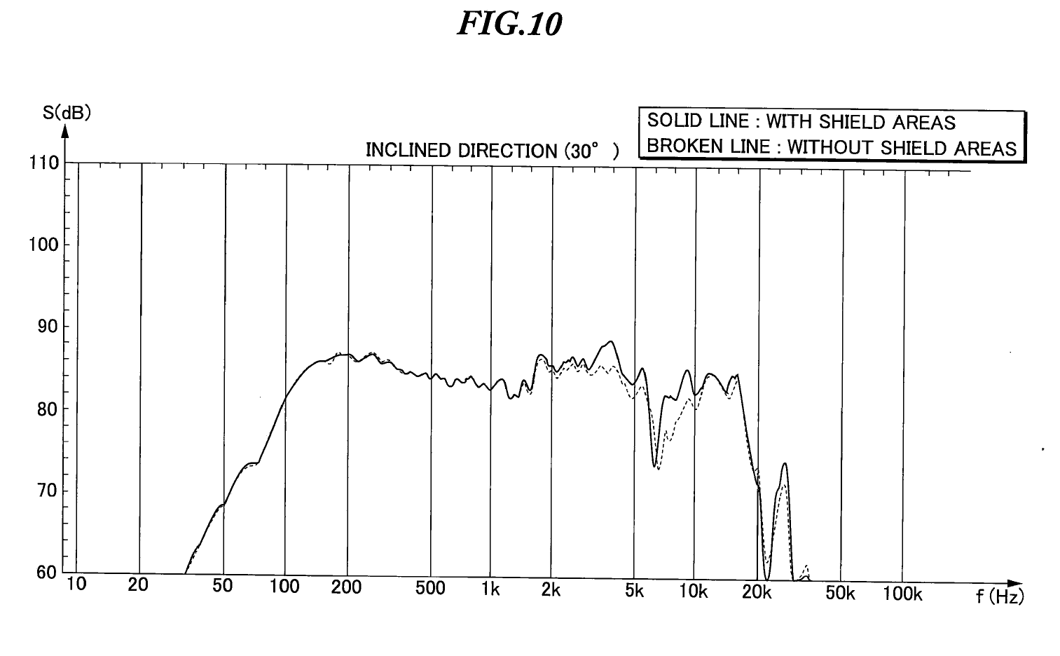

FIG. 9 is a graph showing a frequency response in the right a head direction (0°) of the speaker device 1 equipped with the grille 4 formed according to an embodiment of the present invention and that of a speaker device equipped with a conventional grille. FIG. 10 is another graph showing a frequency response in an inclined direction (30°) of the speaker device 1 equipped with the grille 4 formed according to an embodiment of the present invention and that of a speaker device equipped with a conventional grille. These frequency responses correspond to the results of the measurements performed in a manner such that the sound pressure levels at 1 m point correspond to frequencies so as to form continuous curves. In FIGS. 9 and 10, solid lines represent the measurement results of the speaker device 1 equipped with the grille 4 formed according to an embodiment of the present invention, while the broken lines represent the measurement results of a conventional speaker device equipped with a conventional grille.

[A Conventional Speaker Device]

As shown in FIGS. 9 and 10, regarding an inclined direction (30°) rather than a right ahead direction, a conventional speaker device has a remarkable decrease in sound pressure level within a frequency range of about 5 to 8 kHz. Such a decrease in sound pressure level is caused mainly due to the path difference LD1 along the inclined direction, as shown in FIG. 7. As shown in FIG. 9, when there is an interference from a compression wave having a wavelength equal to a half wavelength of the compression wave, there will be a decrease in the sound pressure level within a frequency range (about 5-9 kHz) having a wavelength equal to the half wavelength.

[Speaker Device 1 According to an Embodiment of the Present Invention]

Regarding to the speaker device 1 formed according to an embodiment of the present invention, as shown in FIGS. 8 and 9, although a frequency response in an inclined direction (30°) rather than a right ahead direction causes a result that a sound pressure level within a frequency range of about 5 to 9 kHz will decrease, such a decrease is smaller than a conventional speaker device 1, so that a resulting sound pressure level is greatly improved as compared with the conventional speaker device.

Moreover, since the grille 4 has the open area 41 in which the entire outer diameter of the diaphragm 223 is in an open state in the right ahead direction of the diaphragm 223, the compression wave emitted from the diaphragm 223 in the right ahead direction will transmit through the grille 4 with a low acoustic load, thereby preventing a decrease in the sound pressure level. On the other hand, if simply a reflection plate is formed for providing a directivity to the front side of the diaphragm, a sound quality in the right ahead direction will become deteriorated. To solve this problem, the grille 4 of the present invention is formed with the open area 41 in the right ahead direction, so that a sound quality in the right ahead direction will not become deteriorated.

As described above, the speaker device 1 of the present embodiment is comprised of the diaphragm 223 and the grille 4 provided in front of the diaphragm 223. The grille 4 has the open area 41 which is located in front of the diaphragm 223 and allows the entire diameter of the diaphragm 223 to be open in the right ahead direction of the diaphragm 223. The grille 4 also has the shield areas 42 capable of shielding part of the diaphragm 223 in an inclined direction of the diaphragm 223. In this way, it is possible to prevent a sound quality deterioration in the inclined direction using a simple structure. Moreover, since the above-described grille 4 is formed with the open area 41 in the right ahead direction, there would be no sound quality deterioration in the right ahead direction.

Moreover, since the shield areas 42 of the present embodiment are formed on left and right sides of the open area 41 so as to shield part of the vibration surface of the diaphragm 223 in an inclined direction on left or right side, it is possible to prevent a sound quality deterioration in an inclined direction on both the left and right sides.

In more detail, the shield areas 42 include first and second shield areas 421 and 422 on left and right sides of the open area 41, with the first shield area 421 shielding part of left or right side vibration surface of the diaphragm 22 in an inclined direction on the left or right side, but the second shield area 422 formed into a shape not covering the vibration surface of the diaphragm 223 in an inclined direction. In this way, it is possible to prevent a sound quality deterioration in an inclined direction on the left or right side. Namely, in an inclined direction on left or right side, either the first shield area 421 or the second shield area 422 is formed into a shape capable of shielding the vibration surface of the diaphragm 223, thereby making it possible to prevent a sound quality deterioration in an inclined direction, without applying any additional acoustic load.

Besides, since the shield areas 42 can shield an area near the edge of the diaphragm 223 in the right ahead direction of the diaphragm 223, even if in an inclined direction where the shield areas 42 are formed, it is still possible to prevent a sound quality deterioration using the shield areas 42 to shield part of the diaphragm 223.

Moreover, the speaker device 1 of the present embodiment is so formed that the low-pitched sound playback speaker 2 and the high-pitched sound playback speaker 3 are positioned concentrically on an identical axis. Further, since the high-pitched sound playback speaker 3 is formed with the shield cover 34, and since part of the diaphragm 223 can be shielded by the shield cover 34 and the shield areas 42 in an inclined direction, it is exactly possible to prevent a sound quality deterioration.

However, the present invention is by no means to be limited to the above-described embodiment.

For example, although the speaker device 1 according to the above-described embodiment is provided with two speakers including the low-pitched sound playback speaker 2 and the high-pitched sound playback speaker 3, the present invention should not be limited to such a specific embodiment. In fact, it is also possible for the speaker device of the present invention to include only one speaker, or more than two speakers.

Further, although the speaker device 1 according to the above-described embodiment has been explained based on a speaker device having a cone-shaped diaphragm, the present invention should not be limited to such a specific embodiment. Actually, the speaker device of the present invention may also use a diaphragm which may be dome-shaped, flat, circular, or elliptical.

Moreover, although the speaker device 1 according to the above-described embodiment has been explained based on a speaker device which is a conductive drive type, the present invention should not be limited to such a specific embodiment. In fact, it is also possible to adopt various other driving types such as electromagnetic type, electrostatic type, and piezoelectric type. Further, as a magnetic circuit, it is possible to use either an internal type magnetic circuit or an external type magnetic circuit.

In addition, although the speaker device 1 according to the above-described embodiment has the grille 4 including the shield areas 42 made of resin and the open area 41 equipped with the protection member (punched net) 43, the present invention should not be limited to such a specific embodiment. For example, the grille 4 may be a protection member (punched net) in which a plurality of apertures are formed in the open area 41 but no aperture is formed in the shield areas 42 or the apertures of the shield areas 42 are clogged, thereby obtaining the advantages of the present invention using a simple configuration.

Moreover, although the above-described embodiment has been described based on a circular speaker, this should not form any limitation to the present invention. For example, the speaker of the present invention may be formed into various other shapes including a generally elliptical shape, a generally rectangular shape, a flat shape or the like.

As described above, the speaker device 1 of the present invention has the diaphragm 223 and the grille 4 provided in front of the diaphragm 223. The grille 4 is formed in a position in front of the diaphragm 223, and has the open area 41 in which the entire diameter of the diaphragm 223 is opened in the right ahead direction of the diaphragm 223, also has the shield areas 42 formed on both sides of the open area 41 for shielding part of the diaphragm 223 viewed in an inclined direction, thereby making it possible to prevent a sound quality deterioration in the inclined direction using a simplified structure.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A speaker grille provided on a front side of a speaker having a diaphragm, said grille comprising:
an open area formed in front of the diaphragm and allowing an entire diameter of the diaphragm to be open in a right ahead direction of the diaphragm; and
shield areas formed outside the open area and shielding part of the diaphragm viewed in an inclined direction of the diaphragm.

2. The speaker grille according to claim 1, wherein the shield areas are formed on left and right sides of the open area, shielding part of vibration surface of the diaphragm on left or right side in an inclined direction.

3. The speaker grille according to claim 2, wherein the shield areas include first and second shield areas on the left and right sides of the open area, the first shield area shields part of the vibration surface of the diaphragm on left or right side in an inclined direction, while the second shield area does not shield the vibration surface of the diaphragm in the inclined direction.

4. The speaker grille according to claim 1, wherein the shield areas are provided to shield diaphragm portions near edge of the diaphragm in the right ahead direction thereof.

5. The speaker grille according to claim 1, wherein said grille consists of a protection member in which a plurality of apertures are formed in the open area, with no aperture formed in the shield areas.

6. A speaker device having a diaphragm and a speaker grille provided in front of the diaphragm, said speaker grille comprising:
an open area formed in front of the diaphragm and allowing an entire diameter of the diaphragm to be open in a right ahead direction of the diaphragm; and
shield areas formed outside the open area and shielding part of the diaphragm viewed in an inclined direction of the diaphragm.

7. The speaker device according to claim 6, wherein the shield areas are formed on left and right sides of the open area, shielding part of vibration surface of the diaphragm on left or right side in an inclined direction.

8. The speaker device according to claim 7, wherein the shield areas include first and second shield areas on the left and right sides of the open area, the first shield area shields part of the vibration surface of the diaphragm on left or right side in an inclined direction, while the second shield area does not shield the vibration surface of the diaphragm in the inclined direction.

9. The speaker device according to claim 6, wherein the shield areas shield diaphragm portions near edge of the diaphragm in the right ahead direction thereof.

10. The speaker device according to claim 6, wherein said grille consists of a protection member in which a plurality of apertures are formed in the open area, with no aperture formed in the shield areas.
